(19) United States
(12) Patent Application Publication
(10) Pub. No.: US 2025/0045462 A1
(43) Pub. Date: Feb. 6, 2025

(54) METHOD OF PROCESSING SEQUENCE DATA, STORAGE DEVICE, AND STORAGE SYSTEM

(71) Applicant: Shanghai Longsys Digital Technology Co., Limited, SHANGHAI (CN)

(72) Inventor: Yanbin KONG, SHANGHAI (CN)

(73) Assignee: Shanghai Longsys Digital Technology Co., Limited, SHANGHAI (CN)

(21) Appl. No.: 18/925,097

(22) Filed: Oct. 24, 2024

Related U.S. Application Data
(63) Continuation of application No. PCT/CN2023/106197, filed on Jul. 6, 2023.

(51) Int. Cl. G06F 21/64; G06F 16/22; G06F 16/2458; G06F 21/60

(52) U.S. Cl. CPC G06F 21/64; G06F 16/22; G06F 16/2474; G06F 21/602

(57) ABSTRACT

The present application discloses a method for processing sequence data, a storage device, and a storage system. The method is applied to a storage device, which processes data in the form of sequence data streams, and includes: the storage device receiving sequence data sent by the host terminal; the storage device storing the sequence data in the form of sequence data streams and setting up corresponding sequence data indexes; the storage device receiving data operation commands for the sequence data from the host terminal, and processing the corresponding sequence data based on the sequence data indexes. Through this method, it is possible to significantly simplify the software stack on the host terminal and reduce the storage access load on the host terminal's processor and memory.

### CROSS REFERENCE TO RELATED APPLICATIONS

The present application is a continuation application of the international application No. PCT/CN2023/106197, filed on Jul. 6, 2023, and contents of which are incorporated herein by its entireties.

### TECHNICAL FIELD

The present disclosure relates to the field of sequence data processing, and in particular to a method of processing sequence data, a storage device, and a storage system.

### BACKGROUND

Storage devices are widely used for storing various data. However, the storage devices are typically based on block storage interfaces, such as storage devices based on NAND medium. Since the storage device stores data based on block storage interfaces, when storing the data, data needs to be divided by block logically and are stored in corresponding storage units.

Therefore, when storing sequence data, the sequence data needs to be encoded, in a specific sequence data format, into a sequence file with continuous address space. The sequence file is split into to blocks logically by file address space, and mapped and stored to physical blocks of block storage device. When reading the stored sequence data, data in corresponding physical blocks of block storage device are obtained and re-organized to obtain the sequence file. The sequence file is decoded to obtain the sequence data. The above process of reading and writing the sequence data is complicated.

The sequence data stored in the storage device loses corresponding sequence information. Thus storage of the sequence data cannot be efficiently organized and managed, efficiency and performance of storage is reduced.

### SUMMARY OF THE DISCLOSURE

The present disclosure a method of processing sequence data, a storage device, and a storage system. In the present disclosure, a software stack at a host terminal is dramatically simplified, occupation of a host-side processor due to a host-side storage access is reduced, the efficiency and performance of storage in practice is improved, and the lifespan of the storage device/system is improved.

In a first aspect, the present disclosure provides a method of processing sequence data, the method is applied to a storage device, the storage device performs data-processing operations in a form of a sequence data stream, the method includes: the storage device receives sequence data sent from the host side; the storage device stores sequence data in the form of sequence data stream and sets up corresponding sequence data indexes; the storage device receives data operation instructions for sequence data from the host side, and performs corresponding processing on the relevant sequence data based on the sequence data indexes.

In some embodiments, the storage device comprises at least one sequence container, each sequence container stores one or multiple categories of sequence data, each sequence container has a unique container ID. The sequence containers set their attributes upon creation and/or after creation; the attribute of the sequence container stores first descriptive information of the stored sequence data; the first descriptive information is configured to enable the host terminal to determine, based on the first descriptive information, a manner of accessing and using the associated sequence data.

In some embodiments, in response to the deletion of a sequence container within the storage device, all sequence data stored within the sequence container is deleted When deleting a sequence container, in response to the storage device being set to data protection mode, deleting the sequence container is prohibited.

In some embodiments, each sequence container comprises at least one sequence data stream; each sequence data stream stores sequence data in a same category and has a unique sequence data stream ID. In response to a sequence data stream deletion instruction, the storage device deletes all sequence data on the sequence data stream targeted by the sequence data stream deletion instruction, wherein the sequence data stream is can set to be undeletable, the deletion will fail. The sequence data stream, after being created, sets a sequence data stream attribute; the sequence data stream attribute comprises second descriptive information of data stored on the sequence data stream.

A sequence container has a unique sequence space, which has a corresponding sequence ID. The sequence ID is used to identify the position of the sequence data within the sequence data streams in the sequence container within the sequence space. The chronology of sequence data within a sequence data stream is determined by the magnitude of the sequence ID. The sequence data stream ID and the sequence ID together form a sequence data index, which corresponds to a unique sequence data within the sequence container. Other sequence data can only replace the existing sequence data or be appended after the existing sequence data.

In some embodiments, the sequence container supports a circular overwrite function, which is set with a reserved sequence ID length. When the circular overwrite function is enabled, in response to writing new sequence data into the sequence container, sequence data outside the range formed by the new sequence ID and the reserved sequence ID length is deleted.

In some embodiments, a sequence data index set is used to identify multiple sequence data indexes, which are employed in sequence data commands to operate on multiple sequence data simultaneously. The sequence data index set is a combination of multiple sequence data indexes, or it is a combination of multiple sequence data stream IDs and sequence IDs. Alternatively, the sequence data index set is a combination of a sequence ID range and at least one sequence data stream ID, used to identify all sequence data within the sequence ID range for at least one sequence data stream. The sequence ID range represents the set of all sequence IDs within the range.

In some embodiments, In response to a sequence data deletion command, the sequence data corresponding to the sequence data index set in the target sequence container specified by the deletion command is deleted.

In some embodiments, in response to a sequence data compression command, the sequence data corresponding to the data index set in the compression command is compressed, and the compressed sequence data replaces the original sequence data. When a sequence data stream is set to compression mode, the sequence data written to the sequence data stream is compressed using a given compression algorithm. The compressed sequence data, before being read or used in calculations, is decompressed using a given decompression algorithm to obtain the sequence data prior to compression.

In some embodiments, the storage device, in response to a sequence data merge command, performs a merge operation on the sequence data on the sequence data stream corresponding to the merge command.

In some embodiments, in response to a data protection command, the sequence data corresponding to the data index set in the data protection command is enabled for data protection, making the sequence data and its corresponding sequence data index undeletable or unchangeable. When a sequence container and/or sequence data stream is set to a data protection option, all sequence data on the sequence data stream corresponding to the data protection option, as well as their corresponding sequence data indexes, cannot be deleted or altered.

In some embodiments, when the data protection feature of a sequence container or sequence data stream is enabled, it is not allowed to delete and/or modify the sequence data already written in the protected data stream. Alternatively, when the data protection feature of a sequence container or sequence data stream is enabled, only sequence data with a sequence ID newer than the latest sequence ID in the protected sequence data stream is allowed to be written. Additionally, when the data protection feature of a sequence container or sequence data stream is enabled, only sequence data with a sequence ID within the sequence ID protection range is allowed to be written on all sequence data streams in the sequence container. The sequence ID protection range is determined by the latest sequence ID in the sequence container and the range length of the sequence ID protection zone in the data protection feature of the sequence container.

In some embodiments, When the data protection feature of a sequence data stream is enabled, in response to activating the sequence data stream protection feature, a sequence signature corresponding to the sequence data is added to the signature field of the sequence data tag, to protect the data integrity of the corresponding data stream.

In some embodiments, each sequence container with the data protection feature enabled has a sequence signature private key that cannot be externally obtained. The corresponding sequence signature public key for the sequence signature private key is stored in the attributes of the sequence container, used to verify the data integrity of the protected sequence data stream. The attributes of the sequence container include the sequence signature public key, related information, and a signature of the sequence signature public key and related information by the sequence storage device's security private key. In response to a first verification command, the sequence storage device uses the obtained sequence storage device security public key to verify the signature of the related information, thereby proving the integrity of the sequence signature public key and related information. In response to a second verification command, the sequence data signature is used to verify the integrity of the current sequence ID, current sequence data, current sequence data tag, and the sequence ID and signature of the previous sequence data. The sequence data signature is obtained by signing, using the sequence signature private key, the contents including the sequence ID and signature of the previous sequence data in the sequence data stream, the current sequence ID, current sequence data, and current sequence data tag.

In some embodiments, in response to activating the sequence data stream protection feature, a container signature is obtained by signing the sequence ID and signature information of the latest sequence data on all protected sequence data streams in the sequence container, and the container signature is stored in the attributes of the sequence container. The container signature is used to ensure the integrity of all protected sequence data streams in the sequence storage device.

In some embodiments, in response to a sequence data encryption command, the sequence data corresponding to the sequence data index set in the encryption command is encrypted and stored. When the sequence container or sequence data stream enables the sequence data encryption feature, the corresponding sequence data is encrypted and stored using a designated sequence encryption key. The sequence encryption key is obtained through key generation or exchange.

In some embodiments, the configuration scope of the configuration information for the sequence data stream is within the configuration scope of the configuration information for the sequence container.

In some embodiments, the configuration information for the sequence data stream includes at least one of the following: storage requirements, size, format, tags, query methods, and computation methods of the stream data.

In some embodiments, at least one sequence data tag is configured on the sequence data stream, with the configuration content including at least one of the tag's type, length, default value, and possible tag operations. In response to writing or modifying all sequence data on the sequence data stream, and if the sequence data stream is configured with sequence data tags, the configured sequence data tag data is stored as a supplementary part of the sequence data index. In response to an operation command for the sequence data stream, at least one tag item in the sequence data tags is subjected to rule-based computation, and when the result of the rule-based computation meets the requirements, the operation corresponding to the operation command is executed on the sequence data stream. In response to the sequence data stream being configured with sequence data tags, and if the operation command requires the use of a sequence data index set, tag filtering operations are used to filter and adjust the sequence data index set, resulting in a filtered sequence data index set.

In some embodiments, the sequence container includes at least one sequence data stream. In response to the configuration lock, no new sequence data streams can be added to the sequence container, and the configuration information of at least one data stream cannot be altered.

In some embodiments, the sequence ID is determined by the formation time of the sequence data on the host side.

In some embodiments, sequence data includes audio and video data; the description information of the audio and video data is saved in the attributes of the sequence container. Audio or video stream data from the same source and/or the same encoding is stored using the same sequence data stream, and the corresponding audio or video stream information is saved in the attributes of the corresponding sequence data stream. Audio or video stream data from different sources or different encodings are stored using different sequence data streams.

In some embodiments, in response to a counting operation on at least one sequence data stream, the number of data items on a given sequence data index expression within the at least one sequence data stream is counted. Alternatively, in response to a listing operation on at least one sequence data stream, the number of data items, total data size, and/or sum of tag value within a given index range in the at least one sequence data stream are determined.

In some embodiments, sequence data includes audio or video data; the storage device, in response to a transcoding command, utilizes the codec circuitry within the storage device to decode and then encode the audio or video data corresponding to the first encoding standard specified by the transcoding command, resulting in audio or video data of the second encoding standard and stores transcoded data.

In some embodiments, the sequence data is blockchain data; the storage device stores the sequence data in the form of a sequence data stream and sets up corresponding sequence data indexes, including: using the height value of the blockchain data as the sequence ID, storing the block data of the blockchain data in the form of a data stream, and setting up corresponding sequence data indexes.

In some embodiments, the blockchain data includes main chain data and fork chain data; using the height value of the blockchain data as the sequence ID, the block data of the blockchain data is stored in the form of a data stream and corresponding sequence data indexes are set up, including: using the height value of the main chain data as the sequence ID and storing the main chain data using the first data stream, and using the height value of the fork chain data as the sequence ID and storing the fork chain data using the second data stream.

In some embodiments, the blockchain data includes main chain data and side chain data; using the height value of the blockchain data as the sequence ID, the block data of the blockchain data is stored in the form of a data stream and corresponding sequence data indexes are set up, including: using the height value of the main chain data as the sequence ID and storing the main chain data using the first data stream, and using the height value of the side chain data as the sequence ID and storing the side chain data using the second data stream.

In a second aspect, the present disclosure provides a storage device, which includes a processor, a storage unit, a memory, and an interface unit. The storage unit is used to store computer programs and sequence data. The processor executes the computer programs to implement the methods provided in the first aspect for the storage device. The interface unit connects with the processor on the host side to complete data communication between the host side and the storage device.

In a third aspect, the present disclosure provides a storage system, which includes: a host side; a storage device, the storage device is communicatively connected to the host side, and the storage device is as provided in the second aspect of the present application.

The beneficial effects of the present disclosure are as follows: distinct from the existing technology, the sequence data processing method provided by the present disclosure stores sequence data in the form of data streams and sets up corresponding sequence data indexes. By using the sequence data indexes to locate the corresponding sequence data, it significantly simplifies the software stack on the host side, reduces the host side's storage access's impact on the host processor's occupancy, enhances storage efficiency and performance in practical applications, and extends the lifespan of the storage device. On the storage device side, it can more effectively organize various storage media, reduce unnecessary garbage collection, decrease wear on the storage media, extend the lifespan of the storage device, and lower the use of over-provisioned space and dynamic random-access memory, thereby reducing the cost of the storage device.

### BRIEF DESCRIPTION OF THE DRAWINGS

In order to more clearly illustrate technical solutions in the embodiments of the present disclosure, the accompanying drawings for describing the embodiments will be briefly introduced in the following. Obviously, the following description of the accompanying drawings shows only some of the embodiments of the present disclosure, any ordinary skilled person in the field may obtain other drawings based on these drawings without making creative work.

FIG. 1 is a flow chart of a method of processing sequence data according to a first embodiment of the present disclosure.

FIG. 2 is a flow chart of a method of processing sequence data according to a second embodiment of the present disclosure.

FIG. 3 is a schematic diagram showing a relationship between sequence IDs of sequence containers and sequence data streams according to an embodiment of the present disclosure.

FIG. 4 is an application scenario of the method of processing sequence data according to an embodiment of the present disclosure.

FIG. 5 is an application scenario of the method of processing sequence data according to an embodiment of the present disclosure.

FIG. 6 is an application scenario of the method of processing sequence data according to an embodiment of the present disclosure.

FIG. 7 is a flow chart of a method of processing sequence data according to a third embodiment of the present disclosure.

FIG. 8 is a flow chart of a method of processing sequence data according to a fourth embodiment of the present disclosure.

FIG. 9 is a structural schematic view of a storage device according to an embodiment of the present disclosure.

FIG. 10 is a structural schematic view of a storage system according to an embodiment of the present disclosure.

### DETAILED DESCRIPTION

Technical solutions in embodiments of the present disclosure will be described below by referring to the accompanying drawings of the embodiments of the present disclosure. It is understood that the specific embodiments described herein are for the purpose of explaining the present disclosure only and do not limit the present disclosure. To be noted that, for ease of description, only portions of the structure relevant to the present disclosure, instead of the entire structure, are shown in the accompanying drawings. Based on the embodiments in the present disclosure, all other embodiments obtained by ordinary skilled person in the field without creative work are within the protection scope of the present disclosure.

Reference to “embodiments” herein implies that particular features, structures, or properties described in an embodiment may be included in at least one embodiment of the present disclosure. Presence of the term at various sections in the specification does not necessarily refer to one embodiment, nor a separate or an alternative embodiment that is mutually exclusive of other embodiments. Any ordinary skilled person in the art shall understand, both explicitly and implicitly, that the embodiments described herein may be combined with other embodiments.

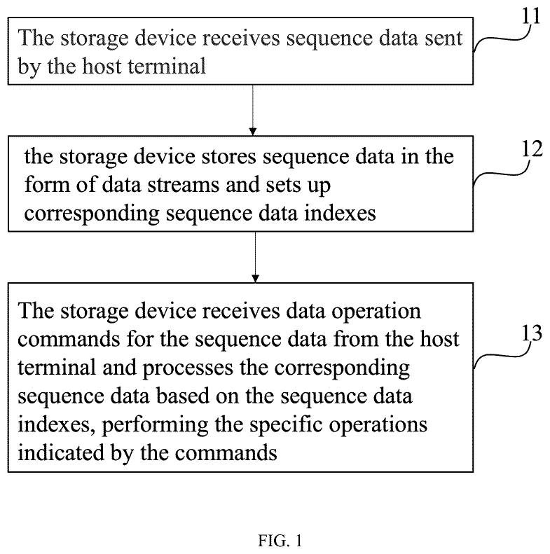

As shown in FIG. 1, FIG. 1 is a flow chart of a method of processing sequence data according to a first embodiment of the present disclosure. The method is applied to a storage device. The storage device performs data processing operations in a form of sequence data streams. The data processing operations may be reading, writing, deletion, querying, and/or computing operations. The method includes following operations.

In an operation 11, the storage device receives sequence data sent from a host terminal.

In some embodiments, the storage device can be applied to one or more of the following scenarios: audio-visual data scenarios, surveillance video scenarios, autonomous driving scenarios and emergency data preservation scenarios for accidents, Internet of Things (IoT) scenarios, and blockchain data scenarios.

Therefore, the host side can be the electronic device in the corresponding scenario. For example, in the surveillance video scenario, the host side manages the processing equipment of multiple surveillance cameras, which is used to collect and process image sequence data. Each sequence data stream stores all image data of a certain camera, and each image sequence data has time information as the sequence ID. In the autonomous driving scenario, the host side can be the autonomous driving system, which collects, processes, and perceives data from various sensors, makes autonomous driving decisions, and completes autonomous driving control. The sequence storage can store data from various autonomous driving sensors such as cameras, ultrasonic, millimeter-wave radar, and lidar, as well as the perception results of the autonomous driving system for these automatic sensor data, the decision results of the autonomous driving system, other sensor data, and the states of various actuators such as throttle and steering wheel, and all data related to autonomous driving. Each of these data types is stored in a separate sequence data stream, with each sequence data having the collection or generation time as the sequence ID, which can fully restore the entire process of autonomous driving. The sequence container supports circular overwriting, which can efficiently and continuously save all autonomous driving data. The sequence container can enable digital signature protection to prove the validity and integrity of the saved data, even the autonomous driving system itself cannot forge or tamper with the already stored autonomous driving data afterwards. In the event of a collision accident, the emergency data protection function can be activated to ensure that the data before and after the collision accident will not be deleted or altered in the sequence storage, serving as valid evidence for accident analysis. The sequence storage can be compatible with autonomous driving systems with different sensors and architectures through the sequence data stream method. In the case of using standard encoding methods for the corresponding sensor data encoding, the same accident analysis software can be used to read, verify, and analyze accident data from different sensors and different architectures of autonomous driving systems.

In an operation 12, the storage device stores sequence data in the form of data streams and sets up corresponding sequence data indexes.

Among them, a data stream is a sequence of bytes that is ordered, has a starting point, and an ending point. Therefore, sequence data can be stored in the form of data streams and corresponding sequence data indexes can be set up. In some embodiments, the sequence data index consists of the sequence data stream ID and the sequence ID, which can uniquely index the corresponding sequence data in the storage device. That is, each sequence data has a corresponding sequence data index. After the sequence data is stored in the form of data streams, the stored sequence data can be managed based on the sequence data index corresponding to the data stream.

Among them, different sequence data streams are created for data from different sources, formats, and meanings to store the corresponding sequence data. For example, a separate sequence data stream is created for data from different hosts to save the sequence data corresponding to each host; for example, a sequence data stream is created for sequence data from different sensors to store the sequence data corresponding to each sensor; for example, separate sequence data streams are created for data with different meanings, such as creating sequence data streams for sensor data, sensor data perception results, automated decision results, and the execution status of decision results, respectively. A sequence data index can be established for the sequence data in the sequence data stream. When processing sequence data, the corresponding sequence data can be read based on the sequence data index and further logical operations can be performed.

By storing sequence data in the form of sequence data streams, the sequence data is not fragmented and can be stored and retrieved as a whole. This simplifies the corresponding processing logic between the host side and the storage device, as the host side only needs to form the sequence data, which can then be stored in the storage device through the communication interface.

In an operation 13, the storage device receives data operation instructions for sequence data sent by the host side and processes the corresponding sequence data based on the sequence data index.

The data operation instructions can be read, write, delete, query, and/or compute operation instructions for the sequence data. By receiving read, write, delete, query, and/or compute operation instructions for the sequence data from the host side, the storage device can quickly query the corresponding sequence data through the sequence data index and perform the corresponding processing on it.

In this embodiment, compared with storage devices using block storage interfaces in related technologies such as SSDs (Solid State Disks), UFS (Universal Flash Storage), SD cards (Secure Digital Memory Cards), and USB drives, storing sequence data in the form of sequence data streams and setting up corresponding sequence data indexes can greatly simplify the software stack on the host side, reduce the occupation of the host processor by storage access on the host side, improve storage efficiency and performance in practical applications, and extend the lifespan of the storage device. On the storage device side, it can more effectively organize various storage media, reduce unnecessary garbage collection, reduce wear on the storage media, extend the lifespan of the storage device, reduce the use of over-provisioned space and dynamic random access memory, and lower the cost of the storage device.

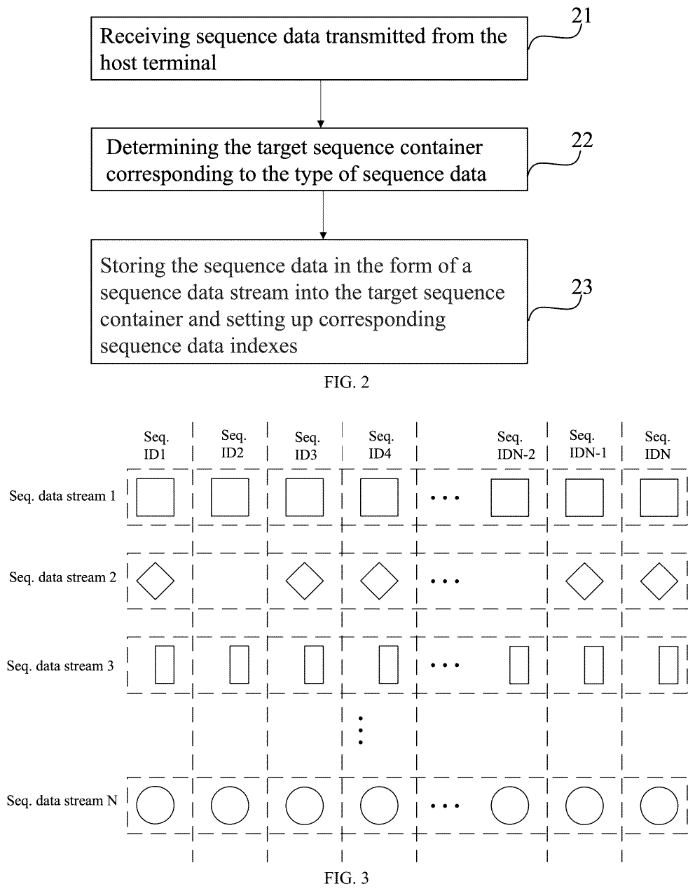

As shown in FIG. 2, FIG. 2 is a flowchart illustrating the second embodiment of the sequence data processing method provided by this disclosure. It is applied to a storage device that processes data in the form of sequence data streams. The storage device includes at least one sequence container, each configured to store one or multiple types of sequence data. A sequence container is a unit in the storage device for storing sequence data, and all sequence data is stored in their corresponding sequence containers, each with a unique sequence container ID. The storage device can add new sequence containers to store different types of sequence data. The method includes the following operations.

In the operation 21, receiving sequence data sent from the host side.

The storage device can have multiple communication interfaces, each capable of communicating with a host side. Specifically, sequence data from each host side can be categorized. For example, categorization can be done based on the host side or based on the data from the host side. That is, a corresponding category can be set for each sequence container in the storage device or storage system, for storing sequence data of that particular category.

Each sequence container can have different configurations. Based on the configuration of the sequence container, it can have varying size limits, different sequence container description information, store sequence data with distinct characteristics, support different types of sequence data streams, and provide varying read/write, query, and computational capabilities. These configurations enable the implementation of different levels of data storage security and performance.

Furthermore, at the host side, corresponding storage service programs can be matched based on the configuration of the sequence containers, directly providing data services to the upper-layer applications of the host side. By standardizing the configuration of sequence containers, a software ecosystem and applications corresponding to the storage device can be constructed at the host side.

In an operation 22: determining the target sequence container corresponding to the category of the sequence data.

In an application scenario, the storage device includes multiple sequence containers, such as Sequence Container A, Sequence Container B, and Sequence Container C. Sequence Container A corresponds to Category a, Sequence Container B corresponds to Category b, and Sequence Container C corresponds to Category c. If the currently received sequence data belongs to Category b, then Sequence Container B can be determined as the target sequence container.

In an operation 23: storing the sequence data in the form of a sequence data stream into the target sequence container and setting up the corresponding sequence data index.

Storing the sequence data as a sequence data stream into the target sequence container and establishing the corresponding sequence data index.

The sequence container has a unique sequence space, which has a corresponding sequence ID. The sequence ID is used to describe the position of the data within the sequence data stream of the sequence container in the sequence space. Step 23 involves storing the sequence data into the corresponding data space based on the sequence ID of the sequence data and the sequence data stream ID, and setting up the corresponding sequence data index. That is, the sequence data stream ID and the sequence ID together form the sequence data index.

The chronological relationship of sequence data within a sequence data stream is determined by the number magnitude of the sequence ID., which can be compared, used in ranges, and/or subjected to addition and subtraction operations. Within the same sequence data stream, sequence data is unique, meaning that within a particular sequence data stream, a specific sequence data ID can have at most one instance of data.

The sequence ID can be represented using a number of bits that is not limited to 32 bit, 64 bit, 128 bit, or 256 bit lengths. Specifically, the length of the sequence data index can be set according to actual needs. The longer the length of the sequence data index, the more sequence data it can store.

In an application scenario, in response to deleting the target sequence container in the storage device, all sequence data stored within the target sequence container will be deleted. The deletion of the sequence container can be either full deletion or partial deletion, such as deleting one sequence container.

In some embodiments, the storage device's sequence container can be set to a data protection mode, which is designed to safeguard the sequence container against deletion and to protect the sequence data stored within it. Specifically, when attempting to delete a target sequence container, the storage device, upon being set to the data protection mode, will not allow the deletion of the target sequence container.

Furthermore, the sequence container can be configured with attributes either at the time of creation and/or after creation; these attributes store the first description information of the sequence data contained within. The first description information serves to enable the host side to determine the method of accessing and utilizing the relevant sequence data based on this information. That is, the host side, by obtaining the first description information from the attributes of the sequence container, can ascertain the manner in which to access and use the associated sequence data.

In some embodiments, each sequence container may contain at least one sequence data stream, with each sequence data stream storing sequence data of the same type and having a unique sequence data stream ID. Additionally, each sequence container has the capability to add new sequence data streams.

The storage device, in response to a sequence data stream deletion command, deletes all sequence data associated with the sequence data stream corresponding to the deletion command. However, the target sequence data stream can be set to be undeletable, thereby protecting the data on that stream from being deleted. After creation, attributes of the sequence data stream are set; these attributes include the second description information of the data stored on the sequence data stream. This second description information assists the host side in accessing and utilizing the data on the sequence data stream.

In some embodiments, the aforementioned sequence container possesses a unique sequence space, which has an associated sequence ID. This sequence ID is used to describe the position of the data within the sequence data streams in the sequence container within the sequence space. As illustrated in FIG. 3, each sequence data stream within the sequence space has corresponding sequence IDs for its sequence data. For example, the sequence data in Sequence Data Stream 1 corresponds to Sequence ID1, ID2, ID3, ID4, IDN-2, IDN-1, and IDN. The sequence data in Sequence Data Stream 2 corresponds to Sequence ID1, ID3, ID4, IDN-1, and IDN. The sequence data in Sequence Data Stream 3 corresponds to Sequence ID1, ID2, ID3, ID4, IDN-2, IDN-1, and IDN. Similarly, the sequence data in Sequence Data Stream N corresponds to Sequence ID1, ID2, ID3, ID4, IDN-2, IDN-1, and IDN.

The sequence ID is represented using a numerical value of any length, such as 32 bit, 64 bit, 128 bit, or 256 bit. Within the same sequence data stream, each identical sequence ID corresponds to a unique piece of sequence data. The sequence IDs exhibit an increasing or decreasing relationship, which is determined at the time of creating the sequence container. The chronological order of sequence data within the sequence data stream is determined by the magnitude of the sequence ID; that is, by comparing the sequence ID magnitudes, one can ascertain the chronological order of the sequence data. The sequence ID can undergo interval addition and subtraction operations, which can be used to describe a certain sequence space position and the space within a certain sequence distance before and after it. This allows for the description and determination of sequence data on the sequence space.

The sequence data stream ID and the sequence ID together form the sequence data index, which corresponds to a unique piece of sequence data within the sequence container. Within the same sequence data index, there can be at most one instance of sequence data; any additional sequence data can only replace the existing sequence data or be appended after the existing sequence data.

Sequence data is stored within the sequence containers of the storage device, organized and stored according to the sequence data index.

Furthermore, the sequence container supports a circular overwrite function, which is configured with a reserved sequence ID length. Specifically, when the circular overwrite function is enabled, in response to writing new sequence data into the sequence container, the sequence data outside the interval formed by the new sequence ID and the reserved sequence ID length is deleted. That is, within the circular overwrite function, a storage-retained sequence ID length is specified. When new sequence data is written into the sequence container, the old sequence data outside the interval formed by the latest sequence ID and the reserved sequence ID length will be automatically deleted, thereby reclaiming the storage medium space occupied by the deleted sequence data. If the reserved sequence ID length is set to 5, and currently there are sequence ID1, ID2, ID3, ID4, and ID5, upon writing new sequence data corresponding to sequence ID6 with the circular overwrite function enabled, the sequence data corresponding to sequence ID1 will be deleted, while the sequence data corresponding to sequence ID2, ID3, ID4, ID5, and ID6 will be retained.

This circular overwrite function strategically arranges the storage locations of sequence data with the same or similar sequence IDs across different sequence data streams within the sequence container. When sequence data corresponding to a sequence ID is overwritten, the complete storage medium space is directly reclaimed. This approach balances the wear on the medium while avoiding garbage collection operations, thereby reducing write amplification caused by garbage collection, minimizing wear on the storage medium, and enhancing the lifespan of the storage medium.

In some embodiments, a sequence data index set is used to denote multiple sequence data indices, which are employed in sequence data commands to simultaneously operate on multiple sequence data.

The sequence data index set is a combination of multiple sequence data indices, or alternatively, the sequence data index set is a combination of multiple sequence data stream IDs and sequence IDs, used to identify the sequence data corresponding to the sequence IDs on multiple sequence data streams.

In some embodiments, a sequence ID range represents the set of all sequence IDs contained within it. The sequence data index set combines the sequence data stream ID with this sequence ID range to identify all sequence data on the corresponding stream where the sequence IDs are within the range.

In some embodiments, the sequence data index set is a combination of multiple sequence data stream IDs and sequence ID ranges, used to identify all sequence data across multiple sequence data streams where the sequence IDs fall within the specified sequence ID ranges.

In some embodiments, the sequence container can be configured with a corresponding sequence data deletion function. Upon receiving a sequence data deletion command, the sequence data corresponding to the sequence data index set within the target sequence container specified by the deletion command is deleted, thereby releasing the storage space of the target sequence container.

In an application scenario, the storage space of the sequence container can be set according to actual needs and can be configured with a corresponding sequence data deletion function. For instance, in response to the available storage space of the target sequence container falling below a threshold, a sequence data deletion command is generated. This command triggers the deletion of data based on the sequence data index, thereby releasing storage space in the target sequence container. For example, if the threshold is set at 10%, when the available storage space drops below 10% of the sequence container's total storage space, data deletion based on the sequence data index is initiated to free up storage space. Specifically, the storage device will delete the corresponding sequence data in order from oldest to newest according to the sequence data index, reclaiming the storage space for storing new data. In some embodiments, the deleted sequence data should be from the same batch of stored data. Based on this, a circular write function can be set for the corresponding sequence container. When the available storage space of the target sequence container is below the threshold, data deletion based on the sequence data index is performed to release storage space in the target sequence container.

In an application scenario, the storage device's sequence container allows for the compression of data on the sequence data streams. The sequence data compression command or the sequence data stream compression setting compresses the sequence data corresponding to the sequence data index set using a specified compression algorithm. For example, in response to a sequence data compression command, the sequence data corresponding to the data index set in the compression command is compressed, and the compressed sequence data replaces the original sequence data.

In response to the sequence data stream being set to compression mode, the sequence data being written to the sequence data stream is compressed using the specified compression algorithm, and then the compressed data is written to the storage medium.

The compressed sequence data, before being read or utilized in calculations, is decompressed using the specified decompression algorithm to restore it to its original, uncompressed state.

In some embodiments, the storage device responds to a sequence data merge command by performing a merge operation on the sequence data within the sequence data stream corresponding to the merge command.

In an application scenario, in response to a sequence data merge command, a merge operation is performed on the data within the target sequence data stream of the target sequence container. The merge operation includes merging and/or reducing the data. Within the specified time-ordered index interval of the designated sequence data stream, according to a given time-ordered index function, time-ordered data that meets the conditions of the time-ordered index function is deleted. Then, the sequence data is merged forward or backward according to the sequence data index, thereby reducing the effective data size in the sequence container and releasing storage space. Different time-ordered data types may support merging and the types of merge operations they support vary. The data compression function for sequence data can be pre-configured according to the data type.

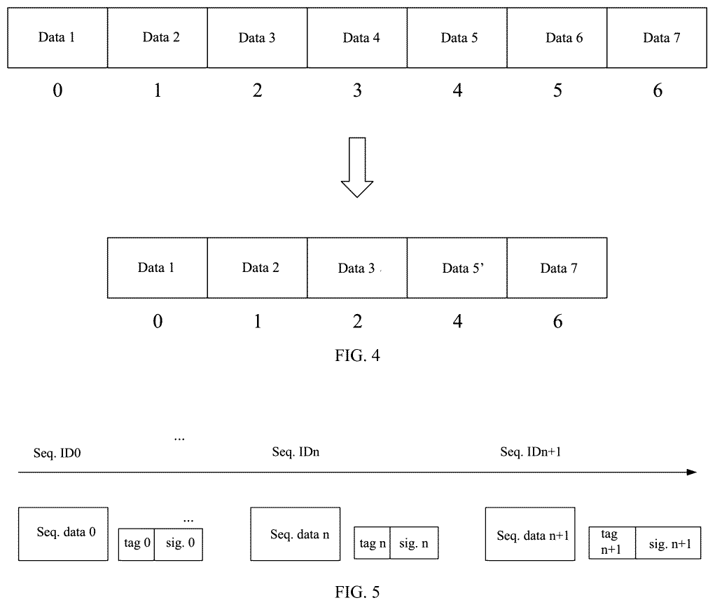

Following illustration is made by referring to FIG. 4.

As depicted in FIG. 4, Data 1 corresponds to Sequence ID 0, Data 2 to Sequence ID 1, Data 3 to Sequence ID 2, Data 4 to Sequence ID 3, Data 5 to Sequence ID 4, Data 6 to Sequence ID 5, and Data 7 to Sequence ID 6. In response to a data merge command, which requires merging Data 4, Data 5, and Data 6, the command specifies deleting Data 4 and Data 6 according to their respective Sequence IDs, using selected merge algorithm combines Data 4, Data 5, and Data 6 into a new Data 5′, thereby freeing up the storage space previously occupied by two Sequence IDs for storing new sequence data.

In an application scenario, the sequence container can be configured with a prohibition on deletion function. Once this function is enabled, the data that has been written into the sequence container cannot be deleted. For example, in response to a data protection command, data protection operations are performed on the data within the target sequence data stream of the target sequence container. The data that is protected in this manner cannot be deleted and/or altered.

However, when the circular write function is enabled, the sequence storage container can reclaim space when it is about to run out of available space in order to write new data.

In response to a data protection command, the sequence data corresponding to the data index set within the command is enabled for data protection. The sequence data and the corresponding sequence data index that are associated with the data index set cannot be deleted or altered, ensuring the integrity and consistency of the data within the sequence data index set.

In response to the sequence container and/or sequence data stream being set to the data protection option, all sequence data on the corresponding sequence data streams specified in the data protection option and the associated sequence data indices cannot be deleted or altered.

In some embodiments, when the data protection function of the sequence container or sequence data stream is enabled, it is not permitted to delete and/or modify the sequence data that has already been written to the protected sequence data stream.

In some embodiments, when the data protection function of the sequence container or sequence data stream is activated, only sequence data with a sequence ID that is newer than the latest sequence ID in the protected sequence data stream is allowed to be written.

In some embodiments, when the data protection function of the sequence container or sequence data stream is enabled, only sequence data with sequence IDs that fall within the protected sequence ID interval is allowed to be written on all sequence data streams within the sequence container.

The protected sequence ID interval is determined by the latest sequence ID in the sequence container and the interval length specified in the sequence container's data protection function.

In some embodiments, when the data protection function of the sequence container or sequence data stream is activated, the protected sequence data stream does not allow deletion and/or modification of the sequence data that has already been written. Additionally, when the data protection function is enabled, only sequence data with a sequence ID that is newer than the latest sequence ID in the current sequence data stream is permitted to be written into the protected sequence data stream.

In some embodiments, when the data protection function of the sequence container or sequence data stream is enabled, the protected sequence data stream does not allow deletion and/or modification of the sequence data that has already been written. Furthermore, when the data protection function is activated, only sequence data with sequence IDs that fall within the protected sequence ID interval is allowed to be written on all sequence data streams within the sequence container.

The protected sequence ID interval is determined by the latest sequence ID in the sequence container and the interval length specified in the sequence container's data protection function.

In some embodiments, when the data protection function of the sequence container or sequence data stream is activated, the protected sequence data stream does not allow deletion and/or modification of the sequence data that has already been written. Additionally, when the data protection function is enabled, only sequence data with a sequence ID that is newer than the latest sequence ID in the current sequence data stream is permitted to be written into the protected sequence data stream. Furthermore, when the data protection function is activated, only sequence data with sequence IDs that fall within the protected sequence ID interval is allowed to be written on all sequence data streams within the sequence container.

The protected sequence ID interval is defined by the latest sequence ID in the sequence container and the sequence ID protection interval specified within the sequence container's data protection function.

In some embodiments, when the data protection function of the sequence container or sequence data stream is enabled, in response to activating the sequence data stream protection function, a sequence signature is added to the signature field of the sequence data tag corresponding to the sequence data. This sequence signature is used to protect the data integrity of the corresponding sequence data stream. Any third party can verify the integrity of the protected sequence data stream using the public key for the signature stored in the attributes of the sequence container.

In some embodiments, each sequence container that has its data protection function enabled possesses a sequence signature private key, which is not accessible externally. The corresponding sequence signature public key for this private key is stored in the attributes of the sequence container and is used to verify the data integrity of the protected sequence data stream. The sequence signature public key can be obtained in response to executing a command to retrieve the sequence container's attributes. The attributes of the sequence container include the sequence signature public key, related information, and a signature from the sequence storage device security private key over the sequence signature public key and the related information. The signature of the related information can be verified using the sequence storage device security public key obtained from the sequence storage, thereby proving the integrity of the sequence signature public key and the related information.

In some embodiments, upon receiving a first verification command, the signature of the associated information is verified using the sequence storage device security public key retrieved from the sequence storage device. This process establishes the integrity of the sequence signature public key and the associated information.

In response to a second verification command, the integrity of the current sequence ID, current sequence data, current sequence data label, as well as the sequence ID and signature of the previous sequence data, is verified using the sequence data signature. The sequence data signature is generated by signing, with the sequence signature private key, a combination that includes the sequence ID and signature of the previous sequence data on the sequence data stream, the current sequence ID, the current sequence data, and the current sequence data label.

Illustration is provided according to FIG. 5.

Using the sequence signature private key, a signature is generated for the combination that includes the sequence ID and signature of the previous sequence data on the sequence data stream, the current sequence ID, the current sequence data, and the current sequence data label (tag). This resulting sequence data signature is stored in the signature segment of the sequence data label (tag). The sequence data signature serves to verify the integrity of the current sequence ID, the current sequence data, the current sequence data label, as well as the sequence ID and signature of the previous sequence data. As illustrated in FIG. 5, sequence data 0 corresponds to sequence ID0, sequence data label tag0, and sequence data signature 0. Similarly, sequence data n corresponds to sequence IDn, sequence data label tagn, and sequence data signature n. Sequence data n+1 corresponds to sequence ID n+1, sequence data label tagn+1, and sequence data signature n+1.

The sequence data signature can be obtained using the following formula:

Signature n+1=Sign (Key_pri,sequence IDn,signature n,sequence IDn+1,sequence data n+1,tagn+1).

Signature 0=Sign (Key_pri, 0, {0}, sequence ID0, sequence data 0, tag0). When the first sequence data signature on the sequence data stream is applied, the previous sequence ID is 0, and the previous sequence signature is all −0 data.

The Sign denotes a signature function, and the Key_pri denotes the sequence signature private key.

During the integrity verification process, the method of sequentially backtracking verification starting from the sequence data signature corresponding to any sequence data within the sequence data stream is employed. This approach verifies the integrity of any sequence data from one point to another within the sequence data stream, thereby substantiating the integrity of the corresponding sequence data on the sequence data stream. This includes proving the integrity of the data indices on the sequence data stream, the integrity of the sequence data and sequence data labels, and confirming that no new sequence data has been inserted in the middle of the sequence data stream or that any sequence data has been deleted or altered. That is, starting from sequence data n in FIG. 5, the integrity of sequence data n−1 back to sequence data 0 can be sequentially verified. Similarly, starting from sequence data n+1 in FIG. 5, the integrity of sequence data n back to sequence data 0 can be sequentially verified. Since the signature of a subsequent sequence data is related to the preceding sequence data, any modification to the sequence data can be detected through this verification method.

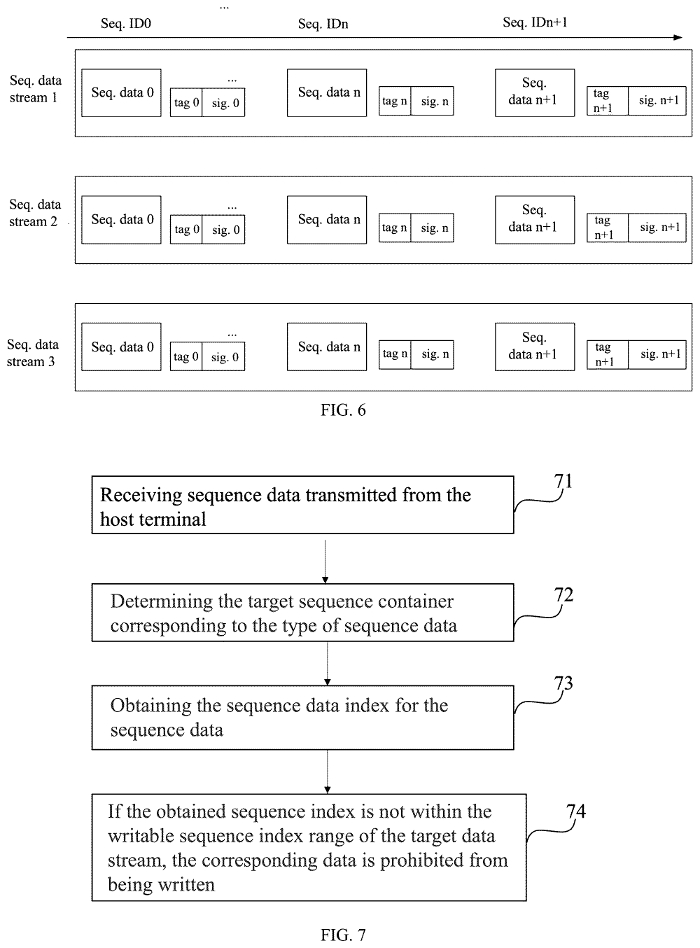

In some embodiments, when the sequence data stream protection feature is enabled, a container signature is generated by signing the sequence ID and signature information of the latest data on all protected sequence data streams within the sequence container. This container signature is then stored in the attributes of the sequence container. The container signature serves to ensure the integrity of all protected sequence data streams within the sequence container. The sequence data stream protection feature can be configured according to the actual sequence data streams. For instance, if there are three sequence data streams, the protection feature can be set for two of them, or alternatively, for all three. The specific number of protected sequence data streams is determined based on actual requirements. Please refer to FIG. 6 for a detailed explanation.

As shown in FIG. 6, the sequence container includes sequence data stream 1, sequence data stream 2, and sequence data stream 3. The sequence data stream protection function can be selected according to actual needs, such as selecting sequence data stream 1, sequence data stream 2, and sequence data stream 3. Alternatively, sequence data stream 2 and sequence data stream 3 can be selected. Another option is to select sequence data stream 1 and sequence data stream 3.

For instance, when selecting sequence data stream 1, sequence data stream 2, and sequence data stream 3, with the sequence data stream protection function enabled, the sequence IDs and signature information of the latest data from sequence data stream 1, sequence data stream 2, and sequence data stream 3 within the sequence container are signed to obtain a container signature. Specifically, the sequence ID and signature information of the sequence data n+1 in sequence data stream 1, sequence data stream 2, and sequence data stream 3 within the sequence container are signed. The container signature is then stored in the attributes of the sequence container, serving to ensure the integrity of all protected sequence data streams within the sequence container.

The verification process is as follows.

First, the container signature is used to verify whether the sequence IDs and signature information of the latest data on all protected sequence data streams match those in the container signature. When they match, the verification process begins by using the target sequence data signature corresponding to the latest sequence data on all protected sequence data streams, and proceeds to verify the integrity of each protected sequence data stream from the latest sequence data to the oldest, thereby proving the integrity of that sequence data stream. This includes proving the integrity of all data indices on the sequence data stream, the integrity of the sequence data and sequence data labels, and confirming that no new sequence data has been inserted in the middle of the sequence data stream or that any sequence data has been deleted or altered. Through this verification method, the integrity of the sequence data in all protected sequence data streams within each container can be validated.

This is illustrated by referring to FIG. 6.

For example, if sequence data stream 1, sequence data stream 2, and sequence data stream 3 are protected, the container signature is used to verify whether the sequence IDs and signature information of the latest data in sequence data stream 1, sequence data stream 2, and sequence data stream 3 match those in the container signature. When they match, the verification process begins by using the target sequence data signature corresponding to the latest sequence data on all protected sequence data streams, and proceeds to verify the integrity of each protected sequence data stream from the latest sequence data to the oldest, thereby proving the integrity of that sequence data stream. This includes proving the integrity of all data indices on the sequence data stream, the integrity of the sequence data and sequence data labels, and confirming that no new sequence data has been inserted in the middle of the sequence data stream or that any sequence data has been deleted or altered. Specifically, when they match, the sequence data signature corresponding to the latest sequence data (sequence data n+1) on sequence data stream 1, sequence data stream 2, and sequence data stream 3 is used to start the verification process in a backward tracing manner, ensuring the integrity of each protected sequence data stream from the latest sequence data to the oldest.

In some embodiments, the current sequence data labels mentioned above can be filtered through tag operations. For instance, within the corresponding sequence data, there are reference frames and normal frames. A 1-bit can be added to the tag of the reference frames to indicate whether they are reference frames. Subsequently, the expression {[stream1, stream2], 1000 . . . 20000, tag:bit1&1} can be used to denote the retrieval of reference frames between 1000 and 20000 from stream1 and stream2.

The sequence tags, can be queried, involved in operations, and accumulated. For example, the expression sum(stream1, 100 . . . 20000, tag:byte1) can be used to accumulate the first byte of the tag for the sequence data between 100 and 20000 on stream1, returning the accumulated value.

In some embodiments, in response to a sequence data encryption command or the configuration of a sequence container and sequence data stream, the sequence data encryption feature is activated. This involves encrypting the corresponding sequence data for storage, thereby safeguarding the sequence data stored on the storage medium from being accessed by unauthorized third parties without the encryption key.

In response to a sequence data encryption command, the sequence data corresponding to the set of sequence data indices within the encryption command is encrypted and stored.

In response to the sequence data encryption function being activated for the sequence container or for the sequence data stream, the corresponding sequence data is encryptedly stored by using a specified sequence encryption secret key. The sequence encryption secret key is obtained by secret key generation or exchange.

In this context, the sequence data encryption command is utilized to encrypt and store the sequence data corresponding to the set of sequence data indices within the command. Sequence data written to a sequence container or a sequence data stream is automatically encrypted and stored using a specified sequence encryption key. The sequence encryption key is obtained through key generation or exchange, and the sequence storage device or system supports various secure key generation or exchange protocols.

In an application scenario, in response to an enhancement command, the corresponding sequence data stream is processed for encryption. For example, a sequence container can activate the sequence data consistency enhancement feature. Once this feature is enabled, the sequence data is signed using a designated storage device private key, a sequence container private key, or a private key exchanged through other protocols. The signed data, along with the sequence data, is read, and the host side can use the public key of the signature to perform cryptographic verification on the entire sequence data stream. This ensures that the entire data sequence remains untampered, thereby guaranteeing the integrity and consistency of the data.

In an application scenario, in response to an operation command for multiple sequence data streams, multiple sequence data streams are retrieved from the target sequence container and the corresponding operations are performed on these streams in accordance with the operation command.

Within the context of a sequence container in a storage device, concurrent operations can be applied to multiple sequence data streams. These multi-stream operations encompass all sequence data stream manipulations, enumeration of streams, and stream matching by excluding enumerated streams. This capability allows for the execution of write, delete, read, query, and/or computational operations on data from multiple sequence data streams within a single sequence container with a single command.

In some embodiments, the configuration information of a sequence container may include at least one of the following: storage requirements, size, format, tags, query methods, and operation methods.

Sequence data streams also possess corresponding configuration information, wherein the configuration scope of the sequence data stream's configuration information is within the configuration scope of the sequence container's configuration information. For example, the size of the sequence data stream is less than or equal to the size of the sequence container. The query methods of the sequence data stream are included within the query methods of the sequence container. The operation methods of the sequence data stream are included within the operation methods of the sequence container. The format of the sequence data stream is included within the format of the sequence container.

Within this context, the configuration information for a sequence data stream includes at least one of the following: data storage requirements, size, format, tags, query methods, and operation methods.

Within this context, at least one sequence data tag is configured on the sequence data stream, with the configuration content including at least one of the following: the type of the tag, its length, default value, and the operations that can be performed on the tag.

In response to all sequence data being written or modified on the sequence data stream, and given that the sequence data stream is configured with sequence data tags, the data of the configured sequence data tags is stored as a supplementary part of the sequence data indices.

In response to an operation command for the sequence data stream, a rule-based operation is performed on at least one tag item within the sequence data tags. When the result of the rule-based operation meets the requirements, the corresponding operation specified by the operation command is executed on the sequence data stream.

Within this context, the tags for the sequence data are provided when the sequence data is written or modified.

Sequence data tags can be modified and overwritten through specialized sequence tag modification commands.

In response to the sequence data stream being configured with sequence data tags, and when an operation command requires the use of a set of sequence data indices, label filtering operations are utilized to filter and adjust the set of sequence data indices, resulting in a filtered set of sequence data indices. Specifically, in response to the sequence data stream being configured with sequence data tags, the set of sequence data indices is augmented with label filtering operations to filter the indices, yielding a set of data indices that meet the criteria of the label filtering operations. These label filtering operations are applicable to any command that utilizes a set of data indices, serving to filter and adjust the set of data indices for the command's operations.

The corresponding operations are performed on the tags of the sequence data within the set of sequence data indices through tag operation commands, and the results of these operations are returned.

Within this context, the tags include at least one tag item. In response to an operation command for the sequence data stream, a rule-based operation is performed on at least one tag item. When the result of the rule-based operation meets the requirements, the corresponding operation specified by the operation command is executed on the corresponding sequence data. For example, when performing operations such as writing, deleting, reading, querying, or computing on the sequence data stream, the tag items are subjected to operations like equality, greater than, less than, matching, and combinations of AND, OR, XOR, etc. Only when the result of these operations is valid will the sequence data stream undergo the corresponding operation.

Referring to FIG. 7, FIG. 7 is a flowchart illustrating another embodiment of a method for processing sequence data provided by the present application. The method is applied to a storage device, which performs read and write operations using sequence data streams. The storage device includes at least one sequence container, each configured to store sequence data of a corresponding type. The method includes:

Step 71: Receive sequence data sent from the host side.

Step 72: Determine the target sequence container corresponding to the type of the sequence data.

Step 73: Obtain the sequence data index for the sequence data.

Within this context, the sequence data index is derived from a combination of the sequence ID and the sequence data stream ID.

Step 74: In response to the target sequence data index in the sequence data index being less than a preset index, the data corresponding to the target sequence data index is prohibited from being written.

Within this context, the preset index is determined by the current maximum sequence data index and the sequence data index protection interval.

Within this context, the preset index can be determined by subtracting the maximum or minimum value from the sequence data index protection interval from the current maximum sequence data index that has been written.

In some embodiments, the comparison between sequence data indices involves the interval of sequence IDs. For example, if the sequence data index is composed of {sequence data stream ID, sequence ID}, then the sequence index space can be represented as {*, sequence ID1, . . . , sequence ID2}, which identifies all sequence data streams in the sequence container where the sequence ID falls between sequence ID1 and sequence ID2. Similarly, matching can also use the same representation method, such as {[sequence data stream 1, sequence data stream 2], sequence ID1, . . . , sequence ID2}, which identifies all data on sequence data stream 1 and sequence data stream 2 where the sequence ID falls between sequence ID1 and sequence ID2.

The sequence data index protection interval is used to safeguard the corresponding sequence interval of sequence data, preventing the sequence data from being altered. This ensures that the sequence data that has already been written cannot be tampered with on the sequence.

In an application scenario, the target sequence container includes at least one sequence data stream. In response to the configuration lock on the sequence data stream, no new sequence data streams can be added to the sequence container, and the configuration information of at least one sequence data stream cannot be altered. For example, the target sequence container includes sequence data streams D, E, and F. In response to the configuration lock on the sequence data streams within the target sequence container, no new sequence data streams can be added, and the configuration information of multiple sequence data streams cannot be changed. This means that the target sequence container can only include sequence data streams D, E, and F.

In some embodiments, the aforementioned sequence data index can be a time index. The time sequence data index can be a counter starting from 0, using time units such as picoseconds, microseconds, milliseconds, seconds, or minutes, and can include various timestamps such as Unix, ISO8601, or RFC2822. In this case, the sequence container can store data generated by various IoT devices, as well as new data edited, processed, or generated based on these data, enabling efficient storage, querying, and computation of IoT-related processing device data. The sequence data index is combined according to the sequence ID and the sequence data stream ID, such as {sequence data stream ID, sequence ID}, where the sequence ID is determined by the formation time of the sequence data on the host side. That is, the sequence ID can be time-based.

The sequence index interval is (combination of sequence data stream IDs, sequence ID interval). Within this, the sequence ID interval can include range(sequence ID1 . . . duration), before(sequence ID1), between(sequence ID1 . . . sequence ID2), after(sequence ID1), latest(duration) which represents the most recent segment of sequence ID interval in the current container, oldest(duration) which represents the earliest segment of sequence ID range data in the current container, all( ), and enumerated combinations: [sequence ID1, sequence ID2, . . . sequence IDx].

The combination of sequence data stream IDs can be: all( ), sequence data stream ID1 . . . sequence data stream ID2, as sequence data streams are incrementally ordered within the sequence container, they can be represented by intervals; before(sequence data stream ID1), after(sequence data stream ID1), and enumerated combinations: [sequence data stream ID1, sequence data stream ID2, . . . , sequence data stream IDx].

In some embodiments, the sequence data includes audio and video data. Here, the sequence ID in the sequence container is the time offset sequence of the sequence data, and all sequence data streams within the sequence container use the same type of sequence ID.

The description information of the audio and video data is stored in the attributes of the sequence container. The host side determines how to access and use the audio and video data based on the description information in the attributes of the sequence container.

Audio and video data originating from the same source and/or the same encoding are stored using the same sequence data stream, with the corresponding audio or video stream information saved in the attributes of the respective sequence data stream. The host side can determine how to decode the audio and video data on the corresponding sequence data stream based on the data description information on the sequence data stream.

Audio or video stream data from different sources or different encodings are stored using different sequence data streams.

Other sensor data, subtitles, interactive elements, processing of audio and video on other sequence data streams, artificial intelligence perception results, and/or artificial intelligence decision results are each stored using a separate sequence data stream.

In some embodiments, in response to a counting operation on at least one sequence data stream, the number of data entries on a given sequence data index expression within the at least one sequence data stream is counted.

Within this context, multiple data within the sequence data stream can be read, written, queried, or operated upon through the sequence data index expression. The sequence data index expression can retrieve all data prior to the target sequence data index, all data following the target sequence data index, all data within a target interval, or the most recent data.

For example, the sequence data index expression can be before(index), where index represents the index subscript, and before(index) indicates all data prior to the sequence data index given as index.

For example, the sequence data index expression can be after(index), where after(index) indicates all data following the sequence data index given as index.

For example, the sequence data index expression can be range(index, duration), where range(index, duration) indicates all data from the sequence data index given as index up to index+duration.

The sequence data index expression can be latest, indicating the retrieval of the most recent data.

In some embodiments, in response to a list operation on at least one sequence data stream, the number of data entries, data size, and/or tags within a given index interval in the at least one sequence data stream are determined.

In some embodiments, the sequence data includes audio and video data. The storage device, in response to a transcoding command, utilizes the encoding and decoding circuitry within the storage device to decode the audio and video data corresponding to the first encoding standard specified by the transcoding command, and then encodes it into audio and video data of a second encoding standard.

In an application scenario, if the sequence data stream data is H.265 video frames, then all sequence data on the corresponding sequence data stream can be decoded using a standard H.265 codec. For instance, if the sequence data stream's sequence data consists of 4K H.265 video frames, in response to a transcoding command, the encoding and decoding circuitry is used to decode the 4K H.265 video frame data stream and encode it into 1080p H.265 video frames for storage. This can be done by directly replacing the 4K H.265 video frames with the encoded 1080p H.265 video frames, or by generating a new sequence data stream and storing the 1080p H.265 video frames according to the sequence ID of the 4K H.265 video frames. Alternatively, they can be stored in another 1080p H.265 video frame stream. This approach eliminates the need for the host side to read and decode the data, thereby enhancing the system efficiency of the host side.

In some embodiments, the sequence data includes audio and video data. The storage device, in response to a processing command, utilizes the encoding and decoding circuitry within the storage device to decode the audio and video data corresponding to the processing command. It then uses the computing circuitry within the storage device to perform calculations on the decoded audio and video data according to the algorithm/model specified by the processing command, resulting in processed results. In an application scenario, if the sequence data is H.265 video frames, then all sequence data on the corresponding sequence data stream can be decoded using a standard H.265 codec. For instance, if the sequence data consists of H.265 video frames, in response to a processing command, the encoding and decoding circuitry is used to decode the H.265 video frames, and the computing circuitry is used to perform calculations on the decoded video data using the specified algorithm/model, yielding the processed results for storage. This can be done by directly updating the processed results as tag data into the tags of the corresponding video frame data, or by generating a new sequence data stream and storing the processed results according to the sequence ID of the H.265 video frames. This approach eliminates the need for the host side to read the data, perform encoding/decoding, and calculations, thereby enhancing the system efficiency of the host side.

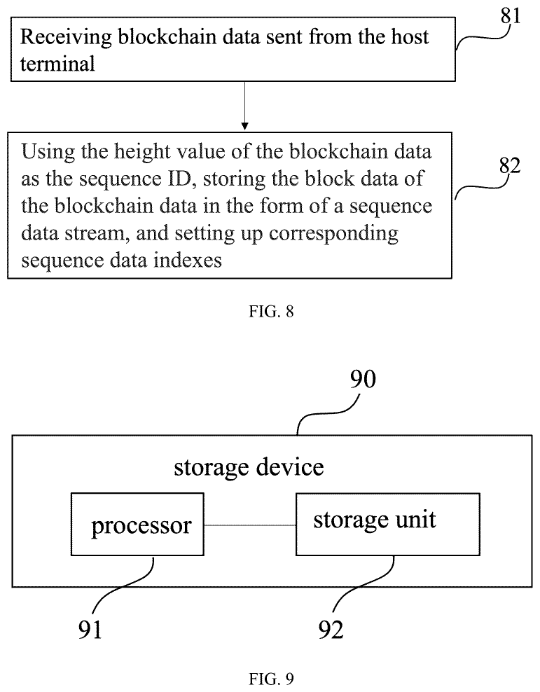

Referring to FIG. 8, FIG. 8 is a flowchart illustrating another embodiment of a method for processing sequence data provided by the present application. The method is applied to a storage device, which performs read and write operations using sequence data streams. The method includes:

Step 81: Receive blockchain data sent from the host device.

Step 82: Use the height value of the blockchain data as the sequence ID, store the block data of the blockchain in the form of a sequence data stream, and set up the corresponding sequence data index.

In some embodiments, if the blockchain data includes both main chain data and forked chain data, Step 82 can be adapted as follows: Use the height value of the main chain data as the sequence ID, store the main chain data using the first sequence data stream, and set up the corresponding sequence data index. Similarly, use the height value of the forked chain data as the sequence ID, store the forked chain data using the second sequence data stream, and set up the corresponding sequence data index.

In some embodiments, where blockchain data includes both main chain data and side chain data, Step 82 can be adapted as follows: Use the height value of the main chain data as the sequence ID, store the main chain data via the first sequence data stream, and set up the corresponding sequence data index. Similarly, use the height value of the side chain data as the sequence ID, store the side chain data through the second sequence data stream, and set up the corresponding sequence data index.

In some embodiments, where blockchain data includes main chain data, forked chain data, and side chain data, Step 82 can be adapted to: Use the height value of the main chain data as the sequence ID, store the main chain data using the first sequence data stream, and set up the corresponding sequence data index. For the forked chain data, use its height value as the sequence ID, store it using the second sequence data stream, and establish the corresponding sequence data index. Furthermore, for the side chain data, use its height value as the sequence ID, store it using the third sequence data stream, and configure the corresponding sequence data index.

In some embodiments, based on the varying requirements of the host device's application, the corresponding application data storage and service-related sequence container configurations, as well as the description information of the sequence containers, the configurations and description information of the supported sequence data streams, can be standardized into a sequence storage container format. On this standardized foundation, software libraries compatible with the sequence storage container format can be developed by multiple parties, along with sequence data applications running on top of these libraries.

Specifically, by obtaining information about the sequence storage container, which includes the configuration of the sequence container, the description information of the sequence container, the configurations of all sequence data streams, and the description information of the sequence data streams, a corresponding standard can be formulated.

Based on the acquired information of the sequence storage container, and the standardized sequence storage format software libraries that are compatible, along with sequence data applications running on these libraries, they are capable of handling all sequence containers that adhere to the sequence storage container format, even if these containers exhibit significant variations in their sequence container configurations, description information, data volume configurations, descriptions, and quantities.

In this context, the compatibility of the program is extended to encompass the sequence data streams, such as when the sequence data stream comprises H.265 video frames, the data within the corresponding sequence data stream can be decoded utilizing the standard H.265 codec. This principle is applicable to the decoding of diverse data types associated with autonomous driving, facilitating the adaptation of standardized applications to various autonomous driving sensors and the ability to read and process data from different architectures of autonomous driving recordings.

Referring to FIG. 9, FIG. 9 is a structural diagram of a storage device according to one embodiment of the present application. The storage device 90 includes a processor 91 and a storage unit 92 connected to the processor 91. The storage unit 92 is used to store computer programs and sequence data. The processor 91 is configured to execute the computer programs to implement the following methods on the storage device:

The storage device performs data processing operations in the form of sequence data streams, which includes: receiving sequence data sent from the host device; storing the sequence data in the form of sequence data stream and setting up the corresponding sequence data index; receiving data operation instructions for the sequence data from the host device, and processing the corresponding sequence data based on the sequence data index.

It can be understood that the processor 91 is configured to execute computer programs to implement any of the methods described in the aforementioned embodiments on the storage device.

In some embodiments, the storage device 90 further includes a communication interface module, through which the storage device 90 communicates with the host device.

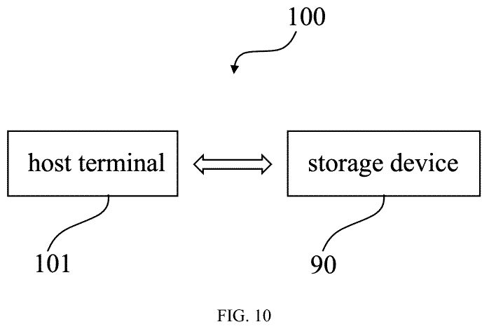

Referring to FIG. 10, FIG. 10 is a structural diagram of a storage system according to one embodiment of the present application. The storage system 100 includes:

The storage system 100 includes: a host terminal 101 and a storage device 90.

In this context, the storage device 90 is in communication connection with the host terminal 101, and the storage device 90 is capable of implementing the following methods:

The storage device performs data processing operations in the form of sequence data streams, which includes: receiving sequence data sent from the host terminal; storing the sequence data in the form of a sequence data stream and setting up the corresponding sequence data index; receiving data operation instructions for the sequence data from the host terminal, and processing the corresponding sequence data based on the sequence data index.

It can be understood that the storage device 90 is capable of implementing any of the methods described in the aforementioned embodiments.

In this embodiment, in contrast to storage devices that utilize block storage interfaces, such as SSDs (Solid State Disks), UFS (Universal Flash Storage), SD cards (Secure Digital Memory Cards), and USB drives, the approach of storing sequence data as data streams with corresponding identifiers offers several advantages. This method simplifies the software stack on the host terminal, reduces the processor load from storage access on the host terminal, and enhances overall storage performance in real-world applications. Additionally, on the storage device side, it enables more efficient management of diverse storage media, minimizes unnecessary garbage collection, extends the lifespan of the storage media by reducing wear, and lowers the need for over-provisioned space and dynamic random-access memory, ultimately reducing the overall cost of the storage device.

Furthermore, sequence data stored as data streams can be read out simultaneously or processed accordingly, which enhances the integrity of the sequence data and facilitates subsequent processing.

In the several embodiments provided by the present application, it should be understood that the disclosed methods and devices can be implemented through other means. For example, the device embodiment described above is merely schematic. The division of the modules or units is only a logical function division, and in practice, there can be other division methods. For instance, multiple units or components can be combined or integrated into another system, or some features can be omitted or not executed.

In the several embodiments mentioned above, if the integrated units are implemented in the form of software functional units and sold or used as independent products, they can be stored on a computer-readable storage medium. Based on this understanding, the essence of the technical solution of the present application, or the part that contributes to the prior art, or all or part of the technical solution can be embodied in the form of a software product. This computer software product is stored on a storage medium and includes several instructions to enable a computer device (which may be a personal computer, a server, or a network device, etc.) or a processor to execute all or part of the steps of the methods described in the various embodiments of the present application. The aforementioned storage medium includes, but is not limited to, USB drives, mobile hard drives, read-only memories (ROM), random access memories (RAM), magnetic disks, or optical disks, among other media capable of storing program code.

The above descriptions are merely embodiments of the present application and do not limit the scope of the patent of the present application. Any equivalent structures or equivalent process transformations made using the content of the description and drawings of the present application, or direct or indirect applications in other related technical fields, are equally included within the scope of patent protection of the present application.

What is claimed is:

1. A method for processing sequence data, performed by a storage device, wherein the storage device performs data processing operations in the form of sequence data streams, the method comprising:
the storage device receiving sequence data sent from a host terminal;
the storage device storing the sequence data in a form of a sequence data stream and setting up a corresponding sequence data index;
the storage device receiving data operation commands for the sequence data from the host terminal, and performing a corresponding process on the corresponding sequence data based on the sequence data index.

2. The method according to claim 1, wherein,
the storage device comprises at least one sequence container, each of the at least one sequence container stores one or multiple types of sequence data, and each sequence container has a unique container ID;
the sequence container is set with attributes upon creation and/or after creation; wherein, the attributes of the sequence container store first description information of the stored sequence data, and the first description information is used by the host terminal to determine a method of accessing and using relevant sequence data based on the first description information.

3. The method according to claim 2, wherein,
in response to deleting any one of the at least one sequence container in the storage device, all sequence data stored within the deleted sequence container is deleted;
when deleting the sequence container, in a case that the storage device is set to data protection mode, the deletion of the sequence container is not allowed.

4. The method according to claim 2, wherein,
each sequence container contains at least one sequence data stream, each of the at least one sequence data stream stores sequence data of a same type and has a unique sequence data stream ID;
the storage device responds to a sequence data stream deletion command by deleting all sequence data on any sequence data stream corresponding to the sequence data stream deletion command, wherein the sequence data stream is capable of being set to be undeletable;
the attributes of the sequence data stream are set after its creation; the attributes of the sequence data stream comprise second description information of the data stored on the sequence data stream.

5. The method according to claim 2, wherein,
the sequence container has a unique sequence space, the sequence space has a corresponding sequence ID, and the sequence ID is used to describe a position of the sequence data in the sequence data stream within the sequence container in the sequence space;
the sequence data stream determines a chronological relationship of the sequence data based on the size of the sequence ID;
the sequence data stream ID and the sequence ID together form the sequence data index, which corresponds to the unique sequence data in a sequence container, and other sequence data is exclusively capable of either replacing existing sequence data or being appended to the existing sequence data.

6. The method according to claim 5, wherein,
the sequence container supports a circular overwrite function, which is set with a reserved sequence ID length;
when the circular overwrite function is enabled, in response to writing new sequence data into the sequence container, sequence data, which is outside the interval formed by the new sequence ID and the reserved sequence ID length is deleted.

7. The method according to claim 2, wherein,
a sequence data index set is used to identify multiple sequence data indexes, which are used in sequence data commands to operate on multiple sequence data simultaneously;
the sequence data index set is a combination of multiple sequence data indexes, or the sequence data index set is a combination of multiple sequence data stream IDs and sequence IDs;
alternatively,
the sequence data index set is a combination of a sequence ID interval and at least one sequence data stream ID, used to identify all sequence data within the sequence ID interval in at least one sequence data stream; wherein, the sequence ID interval is used to represent the set of all sequence IDs within the interval.

8. The method according to claim 7, wherein,
in response to a sequence data compression command, the sequence data corresponding to the data index set in the sequence data compression command is compressed, and the compressed sequence data replaces the original sequence data;
in response to the sequence data stream being set to compression mode, the sequence data written to the sequence data stream is compressed using a given compression algorithm;
wherein, the compressed sequence data is decompressed using a given decompression algorithm before being read or used in calculations, to obtain the sequence data before compression.

9. The method according to claim 7, wherein,
the storage device responds to a sequence data merge command by performing a merge operation on the sequence data on the sequence data stream corresponding to the sequence data merge command.

10. The method according to claim 7, wherein,
in response to a data protection command, the sequence data corresponding to the data index set in the data protection command is enabled for data protection, and the sequence data corresponding to the data index set and the corresponding sequence data index cannot be deleted or altered;
in response to the sequence container and/or the sequence data stream being set to a data protection option, all sequence data on the corresponding sequence data stream and the corresponding sequence data index within the data protection option cannot be deleted or altered.

11. The method according to claim 2, wherein,
in response to the data protection function being enabled for the sequence container or sequence data stream, it is not allowed to delete and/or alter the sequence data already written in the protected data stream; and/or
in response to the data protection function being enabled for the sequence container or sequence data stream, only sequence data with a sequence ID newer than the newest sequence ID in the protected sequence data stream is allowed to be written; and/or
in response to the data protection function being enabled for the sequence container or sequence data stream, only sequence data with a sequence ID within the protected sequence ID interval is allowed to be written on all sequence data streams in the sequence container;
wherein, the protected sequence ID interval is determined by the newest sequence ID in the sequence container and the interval length of the sequence ID protection zone in the data protection function of the sequence container.

12. The method according to claim 11, wherein,
when the data protection function of the sequence data stream is enabled, in response to activating the sequence data stream protection function, a sequence signature is added to the signature field of the sequence data tag for the corresponding sequence data, used to protect the data integrity of the corresponding data stream.

13. The method according to claim 12, wherein,
each sequence container with enabled data protection function has a sequence signature private key, which cannot be obtained externally, and the corresponding sequence signature public key is stored in the attributes of the sequence container, used to verify the data integrity of the protected sequence data stream; wherein, the attributes of the sequence container include the sequence signature public key, related information, and the signature obtained by signing the sequence signature public key and related information with the sequence storage device security private key;
in response to a first verification command, the sequence storage device uses the obtained sequence storage security public key to verify the signature of the related information, proving the integrity of the sequence signature public key and related information;
in response to a second verification command, the sequence data signature is used to verify the integrity of the current sequence ID, current sequence data, current sequence data tag, and the sequence ID and signature of the previous sequence data; wherein, the sequence data signature is obtained by signing the sequence ID and signature of the previous sequence data in the sequence data stream, the current sequence ID, current sequence data, and current sequence data tag with using the sequence signature private key.

14. The method according to claim 12, wherein upon activating the sequence data stream protection function, the sequence ID of the latest sequence data and the signature information on all protected sequence data streams within the sequence container are signed to generate a container signature. This container signature is then stored within the attributes of the sequence container, serving to ensure the integrity of all protected sequence data streams within the sequence storage.

15. The method according to claim 14, wherein, the sequence storage stores:
data from sensors comprising: cameras, ultrasonic, millimeter-wave radars, and lidars; perception results of an autonomous driving system for automatic sensor data;
decision results of the autonomous driving system;
operational state of each actuator; and
data pertinent to autonomous driving;
wherein, the data from sensors, the decision results, the operation state of each actuator, and the data pertinent to autonomous driving are stored in the form of sequence data streams within the same sequence container;
the data protection function is enabled to safeguard integrity and consistency of all data within the sequence container;
the sequence container enables the circular overwrite function as described in the claim 6, allowing for continuous preservation of autonomous driving data within an appropriate storage capacity, ensuring that the most recent autonomous driving data within a certain time frame is saved;
in an event of a collision or an incident during autonomous driving, the sequence container is set to a writing prohibit mode after a certain period following the incident;
after the prohibition is set, no new data is written into the storage container, preventing any existing data from being overwritten; any attempt by a third party to alter the data without detection is thwarted by data integrity verification function of the storage container, ensuring the authenticity of the autonomous driving data.

16. The method according to claim 7, wherein upon receiving a sequence data encryption command, the sequence data corresponding to the set of sequence data indexes within the command is encrypted and stored; and wherein upon the sequence container activating the sequence data encryption function or the sequence data stream activating the sequence data encryption function, the corresponding sequence data is encrypted and stored using a designated sequence encryption key, which is obtained through key generation or exchange.

17. The method according to claim 7, wherein at least one sequence data tag is configured on the sequence data stream, with the configuration content including at least one of the tag type, length, default value, and tag operations that can be performed;
wherein upon writing or modifying all sequence data on the sequence data stream, and when the sequence data stream is configured with the sequence data tag, the configured sequence data tag data is stored as a supplement to the sequence data index;
wherein in response to an operation command for the sequence data stream, at least one tag item in the sequence data tags is subjected to rule-based operations, and when the result of the rule-based operations meets the requirements, the operation corresponding to the operation command is executed on the sequence data stream;
and wherein in response to the sequence data stream being configured with the sequence data tag, and when the operation command requires the use of a set of sequence data indexes, the set of sequence data indexes is filtered and adjusted using tag filtering operations to obtain a filtered set of sequence data indexes.

18. The method according to claim 2, wherein, the sequence container comprises at least one sequence data stream; in response to locking the configuration of the sequence data stream, any new sequence data streams is prohibited from being added to the sequence container, and configuration information of the at least one data stream is prohibited from being changed.

19. The method according to claim 5, wherein, the sequence data comprises audio and video data; descriptive information of the audio and video data is stored in the sequence container attribute;
in all audio and video data:
audio or video stream data from a same source and/or a same encoding are stored in a same sequence data stream, and corresponding audio or video stream information is stored to a corresponding sequence data stream attribute;
audio or video stream data from different sources or different encodings are stored in different sequence data streams.

20. The method according to claim 4, wherein,
in response to a counting operation on the at least one sequence data stream, the number of data on a sequence data index expression in the at least one sequence data stream is counted;
or
in response to a list operation on the at least one sequence data stream, the number of data, a size of data, and/or a tag of data within an index interval in the at least one sequence data stream are determined.

21. The method according to claim 1, wherein the sequence data comprises audio-video data, and wherein the storage device, in response to a transcoding command, utilizes an encoding/decoding circuitry within the storage device to decode the audio-video data corresponding to a first encoding standard specified in the transcoding command and then encode the decoded audio-video data into audio-video data of a second encoding standard.

22. The method according to claim 1, wherein the sequence data is blockchain data;
wherein the storage device stores the sequence data in the form of a sequence data stream and sets up a corresponding sequence data index, comprising: using the height value of the blockchain data as the sequence ID, storing the block data of the blockchain data in the form of a data stream, and setting up the corresponding sequence data index.

23. The method according to claim 22, wherein, the blockchain data comprises main chain data and branched chain data;
the storing the height value of the blockchain data as the sequence ID, storing block data of the blockchain data in the form of the data stream, and setting the corresponding sequence data index, comprises:
storing a height value of the main chain data as the sequence ID, using a first data stream to store the main chain data; storing a height value of the branched chain data as another sequence ID, and using a second data stream to store the branched chain data;
or
wherein, the blockchain data comprises main chain data and side chain data;
the storing the height value of the blockchain data as the sequence ID, storing block data of the blockchain data in the form of the data stream, and setting the corresponding sequence data index, comprises:
storing a height value of the main chain data as the sequence ID, using a first data stream to store the main chain data; storing a height value of the side chain data as another sequence ID, and using a second data stream to store the side chain data.

24. A storage device, comprising a processor, a storage unit, a memory, and an interface unit, wherein the storage unit is used to store computer programs and sequence data, the processor is used to execute the computer programs to implement the method according to claim 1 for the storage device, and the interface unit is connected with the processor at the host end to complete the data communication between the host end and the storage device.

25. A storage system, comprising:
a host terminal;
a storage device, which is communicatively connected to the host terminal, and the storage device is the storage device according to claim 24.
